(19) United States
(12) Patent Application Publication
(10) Pub. No.: US 2006/0026516 A1
(43) Pub. Date: Feb. 2, 2006

(54) Importing text into word processing documents

(75) Inventors: David Clayton LeGrys, Pittsboro, NC (US); Susan Ellen McGuire, Cary, NC (US); David Lloyd Schmidt, Cary, NC (US); Eduardo Kazuo Tanaka, Cary, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/901,567

(22) Filed: Jul. 29, 2004

(51) Int. Cl. G06F 17/21

(52) U.S. Cl. 715/531

(57) ABSTRACT

Methods, apparatus, and computer program products for importing text into word processing documents. A target string that is specified by a user within a word processing document is identified, and references are searched for occurrences of the target string. Passages from the references that include the target string are displayed to the user. The user indicates text to be selected from a displayed passage, for example by highlighting the selected text. The selected text is then inserted into the word processing document.

### BACKGROUND OF THE INVENTION

The present invention pertains to the field of word processing, and pertains more specifically to methods, apparatus, and computer program products for importing text from references into word processing documents.

### BRIEF SUMMARY OF THE INVENTION

A target string that is specified by a user from within a word processing document is identified, and references are searched for occurrences of the target string. Passages from references that include the target string are displayed to the user. The user indicates text to be selected from a displayed passage, for example by highlighting the selected text. The selected text is then inserted into the word processing document.

### BRIEF DESCRIPTION OF THE SEVERAL VIEWS OF THE DRAWINGS

FIG. 1 is a flowchart showing aspects of a method according to the present invention.

FIG. 2 is a block diagram showing exemplary aspects of apparatus according to the present invention.

### DETAILED DESCRIPTION OF THE INVENTION

The present invention will now be described more fully hereinafter, with reference to the accompanying drawings.

The invention may, however, be embodied in many different forms, and should not be construed as limited to the embodiments set forth herein; rather, these embodiments are provided so that the disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an embodiment entirely in hardware, entirely in software, or in a combination of aspects in hardware and software.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java7, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to flowchart illustrations and block diagrams of methods, apparatus (systems), and computer program products according to embodiments of the invention. It will be understood that each block of the flowchart illustrations and/or block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart and/or block diagram block or blocks.

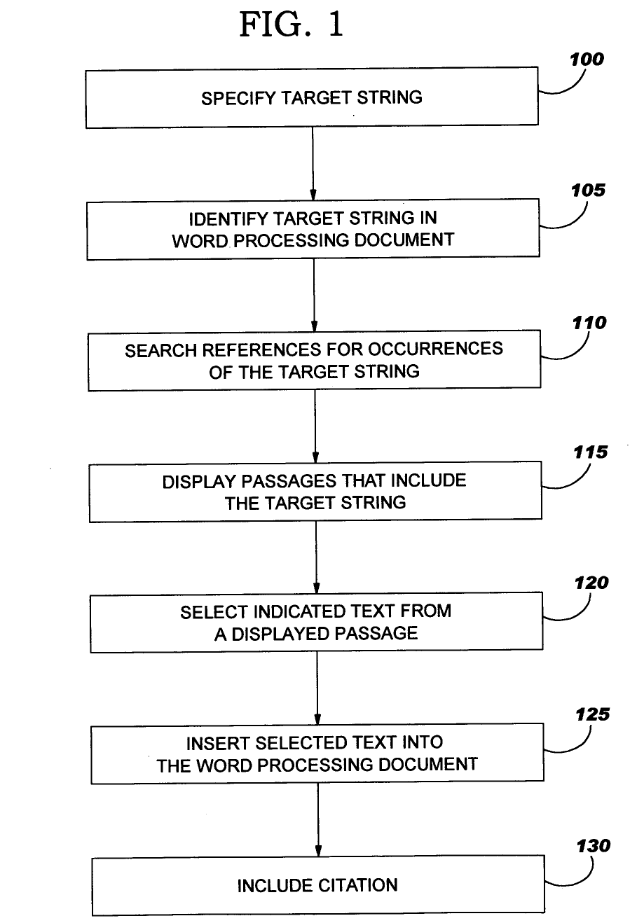

FIG. 1 is a flowchart showing aspects of a method according to the present invention. In a preferred embodiment of the invention, the method is executed within a word processing application program, such as, for example, Lotus® SmartSuite® Word Pro®.

In one exemplary embodiment of the invention, a user may specify a fragment of a desired reference passage, such as a quotation, as a target string within a word processing document. The word processor finds the corresponding passage in a reference, and insert the full passage or an indicated part of the passage back into the word processing document.

For example, the user might specify “Now is the” as the target string by offsetting this fragment using quotation marks, positioning the cursor nearby the fragment, and engaging the search option, for example by mouse-clicking a toolbar button. References would then be searched for passages that contain the target string. In this simple hypothetical example, the references might be an electronic book of familiar quotations, and the works of Shakespeare in electronic form. Two passages might be found, and displayed to the user in a window: “Now is the time for all good men to come to the aid of their party,” and “Now is the winter of our discontent Made glorious summer by this son of York; and all the clouds that loured upon our house in the deep bosom of the ocean buried.” The user, who had intended to include part of the passage from Shakespeare, but only part, might select the text “Now is the winter of our discontent” by highlighting this text in the display window. The word processing application program would then insert the selected text into the word processing document, overwriting or completing the fragment. A citation of Richard III (I.i. 1-4) may also be included in the word processing document.

The user may begin by creating a new word processing document or opening an existing word processing document to edit. As shown in FIG. 1, the user specifies the target string from within the word processing document (step 100). The target string may be a word, a group of words, a phrase, a sentence, and the like, which may include numeric data. The target string may be specified, for example, by highlighting portions of the word processing document displayed on a screen using a computer mouse, or by setting off the target string using predetermined symbols. In the embodiment using predetermined symbols, these symbols may be, for example, quotation marks. Thus the user may put a fragment or loose rendition of a quotation within quotation marks, and thereby specify this material as the target string. The special symbols are not limited to quotation marks, however, and may be other punctuation marks, other kinds of symbols available through a keyboard, or constructions that violate the ordinary conventions of the language in which the word processing document is written. An example of a convention violation in English would be the use of alphanumeric tags that begin with periods or colons.

The target string is identified by the word processing application program in response to encountering the user's specification such as highlighting, predetermined symbols, convention violations, and the like as discussed above (step 105). Responsive to such identification, the word processing application program may present the user with a message such as “Do you want to find associated passages in the references?” and present yes-or-no buttons for the user's answer. In other embodiments, a function may be included in a toolbar or menu that provides an instruction to find the passages in the references that are associated with the specified target string. A passage may be a naturally occurring subsection of a reference, such as a verse, a sentence, a paragraph, or a page; or may be an arbitrary construction, such as a fifty word excerpt that includes the target string.

The references are then searched for the target string (step 110). The search may be exact or may be fuzzy. Here, the distinction between an exact search and a fuzzy search may be explained by analogy to the field of symbolic logic. In symbolic logic, an element is either a member of a set or not, i.e., the probability of membership is one or zero, whereas in fuzzy logic, the probability of membership of an element in a set may have values between zero and one. Likewise, in an exact search, a passage in a reference is returned if and only if the target string is found in the passage, whereas in a fuzzy search, a probability is computed that the target string belongs to the passage, where the computation of the probability may take into account variations in the order of words in the target string, subsets of the specified words of the target string, synonyms of words of the target string, and so forth. If the probability that the target string belongs to the passage exceeds a predetermined threshold, the passage is returned by the search.

Passages returned by the search are displayed to the user (step 115). Display may be made using a window, or a pop-up, or the like. The user may then examine the passages, and indicate text to be selected from a displayed passage. The text to be selected may be an entire passage, or may be part of a passage. Indication may be conveyed by, for example, highlighting part or all of the passage, or checking a box or boxes associated with the passage. The word processing application program then selects the indicated text (step 120), and inserts the selected text into the word processing document (step 125). For example, the selected text may replace a highlighted target string, or may appear between the symbols or violations used to specify the target string, thereby overwriting the target string.

A citation identifying the source of the selected text may be included in the word processing document (step 130). The citation may be in-line, meaning that it appears immediately following the selected text or as a footnote on the same page of the word processing document as the selected text, or may be central, meaning that the citation appears in a dedicated section of the word processing document such as a bibliography or works-cited section at the end of the word processing document.

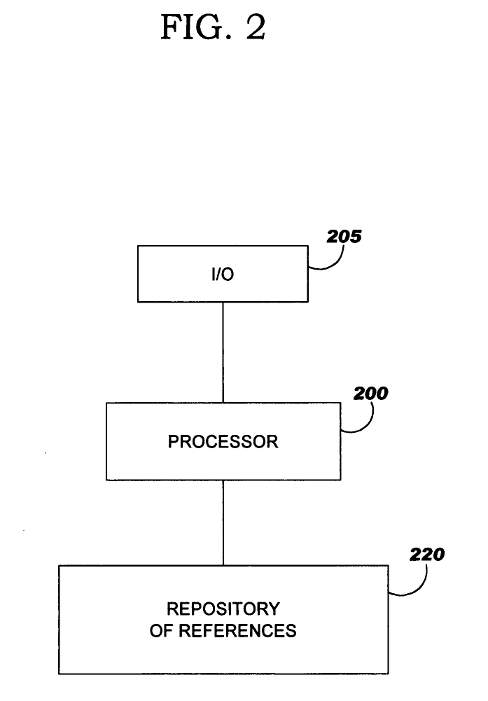

FIG. 2 shows exemplary aspects of apparatus according to the present invention. In this example, a processor 200 executes the word processing application program, and provides execution and control functions for all or part of the method described above with reference to FIG. 1. In a preferred embodiment of the invention, the processor 200 is provided by a personal computer. Conventional input/output devices 205 such as a keyboard, a computer mouse, a video display, and so forth may be operably connected to the processor 200. In other embodiments, the processor 200 may be provided in other ways. For example, the functions of the processor 200 may be provided partly by a client and partly by a server, or entirely or partly by a special purpose workstation, and so forth.

A repository 220 provides storage for references. There may be one reference or a plurality or references stored by the repository. In FIG. 2, the repository 220 is shown schematically as a single entity for descriptive convenience. In other embodiments of the invention, however, the repository 220 may be distributed. For example, the references may be stored on various servers, and accessed by the processor 200 over the Internet or over an intranet. Thus the functions of the repository 220 may be local or remote, and distributed or centralized, with respect to the processor 200.

Although the foregoing has described methods, apparatus, and computer program products for importing text into word processing documents, the description of the invention is illustrative rather than limiting; the invention is limited only by the claims that follow.

We claim:

1. A method for importing text into word processing documents, said method comprising:
identifying a target string specified by a user within a word processing document;
searching at least one reference for occurrences of the target string;
responsive to the searching, displaying to the user one or more passages from the references, wherein each of said one or more passages includes the target string;
selecting text from a displayed passage, responsive to input by the user; and
inserting the selected text into the word processing document.

2. The method of claim 1, further comprising including a citation identifying the selected text in the word processing document.

3. The method of claim 1, wherein the user specifies the target string by highlighting the target string within the word processing document.

4. The method of claim 1, wherein the user specifies the target string by setting off the target string with predetermined symbols within the word processing document.

5. The method of claim 4, wherein the predetermined symbols are quotation marks.

6. The method of claim 1, wherein searching is exact.

7. The method of claim 1, wherein searching is fuzzy.

8. The method of claim 1, wherein the input by the user for selecting text from a displayed passage includes highlighting the text.

9. A computer program product for importing text into word processing documents, the computer program product comprising a computer readable medium having computer readable program code embedded therein, the computer readable program code comprising:
computer readable program code configured to identify a target string specified by a user within a word processing document;
computer readable program code configured to search at least one reference for occurrences of the target string;
computer readable program code configured to display to the user one or more passages from the references, responsive to a search, wherein each of said one or more passages includes the target string;
computer readable program code configured to select text from a displayed passage, responsive to input by the user; and
computer readable program code configured to insert the selected text into the word processing document.

10. The computer program product of claim 9, further comprising computer readable program code configured to include a citation identifying the selected text in the word processing document.

11. The computer program product of claim 9, wherein the user specifies the target string by highlighting the target string within the word processing document.

12. The computer program product of claim 9, wherein the user specifies the target string by setting off the target string with predetermined symbols within the word processing document.

13. The computer program product of claim 12, wherein the predetermined symbols are quotation marks.

14. The computer program product of claim 9, wherein searching is exact.

15. The computer program product of claim 9, wherein searching is fuzzy.

16. The computer program product of claim 9, wherein the input by the user for selecting text from a displayed passage includes highlighting the text.

17. Apparatus for importing text into word processing documents, said apparatus comprising:
a repository for storing at least one reference; and
a processor for identifying a target string specified by a user within a word processing document; searching references in the repository for occurrences of the target string; displaying to the user one or more passages from the references, responsive to searching, wherein each of said one or more passages includes the target string; selecting text from a displayed passage, responsive to input by the user; and inserting the selected text into the word processing document.

18. The apparatus of claim 17, wherein the searching is exact.

19. The apparatus of claim 17, wherein the searching is fuzzy.

20. The apparatus of claim 1, wherein the processor includes a citation of the selected text in the word processing document.
